(19) United States
(12) Patent Application Publication
(10) Pub. No.: US 2010/0077993 A1
(43) Pub. Date: Apr. 1, 2010

(54) Carburetor With Electronic Jets

(76) Inventor: John R. Satterfield, PoughKeepsie, NY (US)

Correspondence Address: LAW OFFICES OF DOUGLAS W. RUDY, LLC, 12101 E. Wethersfield Dr., Scottsdale, AZ, 85259, US

(21) Appl. No.: 12/566,639

(22) Filed: Sep. 24, 2009

Related U.S. Application Data
(60) Provisional application No. 61/100,750, filed on Sep. 28, 2008.

(51) Int. Cl. F02M 7/17

(52) U.S. Cl. 123/439

(57) ABSTRACT

A carburetor has a set of electrically operated fuel injection elements, including acceleration responsive fuel injector and at least one fuel injector. These fuel injectors meter fuel, at the direction of an electronic control device, directly into the fuel delivery passages of a carburetor without the need for float bowls, needle and seat valves and carburetor jets in the carburetor assembly.

### CROSS REFERENCE TO RELATED APPLICATIONS

This application claims priority to provisional patent application 61/100,750, filed Sep. 29, 2008 herein incorporated in its entirety by reference.

### BACKGROUND OF THE INVENTION

### Field of the Invention

The invention relates to a system, apparatus and method for delivering a mixture of gas and air to an internal combustion engine.

The device will use electronic elements to affect carburetor jet settings.

This invention relates generally to carburetors for use on internal combustion engines. More specifically, this invention relates to systems and methods that rely on an electronic jet device that replaces the usual float bowl and jet assembly of a conventional carburetor. One application of the invention is in fuel delivery systems, such as used for internal combustion engines, where thorough an homogeneous emulsification of the fuel and air results in greatly increased engine efficiency.

Numerous references discuss the general subject of carburetor operation. See, for example, Super Tuning and Modifying Holley Carburetors, by Dave Emanuel (S-A Design Books, E. Brea, C A 1988) and Holley Carburetors, by Mike Urich and Bill Fisher (HP Books, Los Angeles, Calif., 1987). A third reference related to fuel injection systems is Fuel Injection Manual, by Don Pfeil, (Haynes North America Inc., Newbury Park, Calif. 1986). All three of these books are incorporated herein by reference. None of these publications discloses the improvements disclosed herein.

U.S. Pat. No. 6,851,663 for “Fluid Emulsification Systems and Methods,” invented by John R. Satterfield, the same inventor as the inventor of this invention, is related in that it includes a disclosure of an early version of an electronic carburetor. This patent is herein incorporated by reference in its entirety. This patent is a related to three other patents in which John R. Satterfield is the inventor, namely: U.S. Pat. Nos. 6,540,210; 6,281,253; and 6,211,251; all of which are herein incorporated in their entirety by reference.

The above summary does not include an exhaustive list of all aspects of the present invention. Indeed, the inventor contemplates that his invention includes all systems and methods that can be practiced from all suitable combinations of the various aspects summarize above, as well as those disclosed in the detailed description below and particularly pointed out in the claims with the application. Such combinations have particular advantages not specifically recited in the above summary.

### SUMMARY OF THE INVENTION

It is an object of the invention to provide an improved fuel delivery device in carburetor-based systems by replacing conventional float bowls and needle and seat assemblies.

It is an object of the invention to improve engine performance and fuel economy in an internal combustion engine that uses a carburetor as the fuel and air distribution method.

It is an object of the invention to provide combustion that is more efficient and diminish undesirable elements of the exhaust gas volume.

It is an object of the invention to the emissions from engines by more thorough and efficient combustion of fuel.

Another object of the invention is to prevent fuel starvation in situations where acceleration forces adversely act on a carburetor.

The above and other objects are achieved by apparatus including an electronically controlled jet device that is integrated into the fuel supply system of a conventional carburetor.

The apparatus, methods and systems presented herein have application not only for internal combustion engines, but also other areas where increased carburetor response under acceleration is desired.

The preferred embodiments of the invention presented here are described below in the drawings and detailed specification. Unless specifically noted, it is intended that the words and phrases in the specification and the claims be given the plain, ordinary and accustomed meaning to those of ordinary skill in the applicable arts. If any other special meaning is intended for any word or phrase, the specification will clearly state and define the special meaning. Likewise, if a noun, term or phrase is intended to be further characterized or specified, such will include adjectives, descriptive terms or other modifiers in accordance with the normal precepts of English grammar. Absent use of such adjectives, descriptive terms or modifiers, it is the intent the nouns, terms or phrases be given their plain and ordinary English meaning to those skilled in the applicable arts.

Further, the use of the words “function,” “means” or “step” in the Specification is not intended to indicate a desire to invoke the special provisions of 35 U.S.C. 112, Paragraph 6, to define the invention. To the contrary, if the provisions of 35 U.S.C. 112, Paragraph 6 are sought to be invoked to define the inventions, the claims will specifically state the phrases “means for” or “step for,” and will also clearly recite a function, without also reciting in such phrases any structure, material or act in support of the function. Thus, even when the claims recite a “means for” or “step for” performing a defined function, if the claims also recite any structure, material or acts in support of that means or step, or that perform the function, then the intention is not to invoke the provisions of 35 U.S.C. 112, Paragraph 6. Moreover, even if the provisions of 35 U.S.C. 112, Paragraph 6 are invoked to define the claimed inventions, it is intended that the inventions not be limited only to the specific structure, material or acts that are described in the preferred embodiments, but in addition, include any and all structures, materials or acts that perform the claimed function as described in alternative embodiments, or that are well known present or later-developed, equivalent structures, material or acts for performing the claimed function.

### BRIEF DESCRIPTION OF THE FIGURES

FIG. 1 is a schematic presentation of a conventional carburetor showing the flow of fluid through the carburetor;

FIG. 2 is schematic presentation of a conventional carburetor showing the flow of fluid through carburetor equipped with electronic jets of the invention;

FIG. 3 is an orthographic view of a carburetor including injector assemblies integral with the carburetor;

FIG. 4 is a top view of the carburetor shown in FIG. 3;

FIG. 5 is an end elevation view of the carburetor shown in FIG. 3;

FIG. 6 is a cross-sectional view taken through plane 6-6 of FIG. 5.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

While the invention is described herein in terms of preferred embodiments and generally associated methods, the inventor contemplates that alterations and permutations of the preferred embodiments and methods will become apparent to those skilled in the art upon a reading of the specification and a study of the drawings.

Accordingly, neither the above description of preferred exemplary embodiments nor the abstract defines or constrains the invention. Rather, the claims variously define the invention. Each variation of the invention is limited only by the recited limitations of its respective claim, and equivalents thereof, without limitation by other terms not present in the claim.

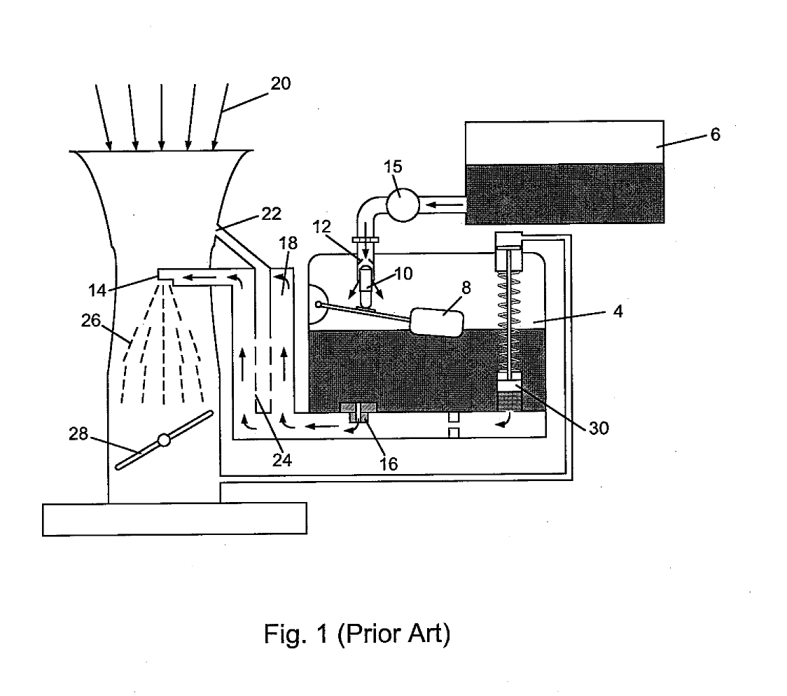

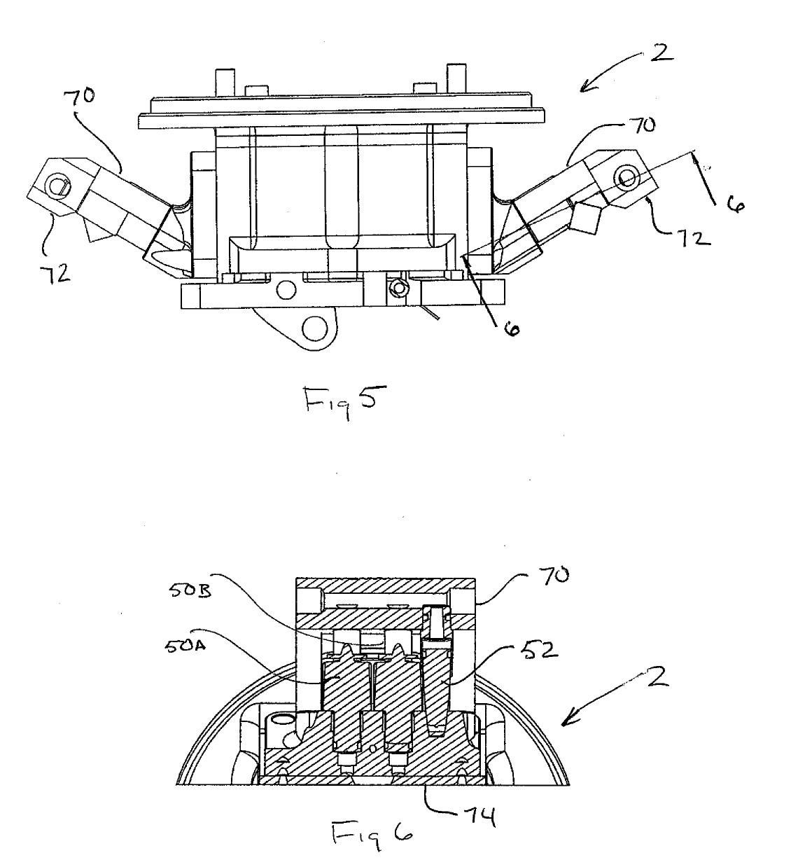

An understanding of the invention can be gained by a reading of the following description along with a review of the drawing FIGS. 1-6.

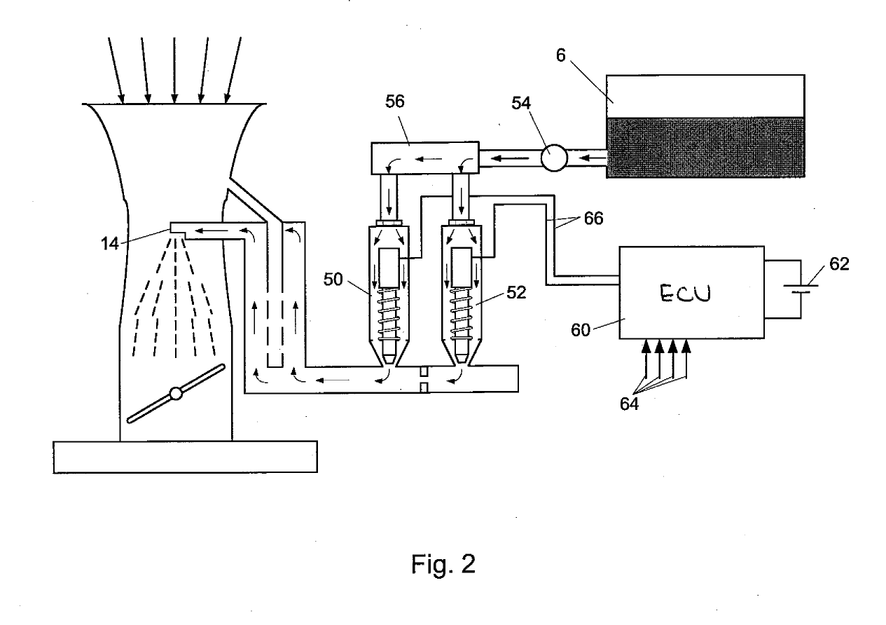

FIG. 1 illustrates the functions of a conventional carburetor as is well known in the art. This carburetor design includes a float bowl into which fuel is pumped. The bowl includes a metering jet and accelerator pump, each provided to allow the fuel to exit the float bowl and enter the main body of the carburetor and the throats of the carburetor. For simplicity, FIG. 1 and FIG. 2 only show the fuel delivery mechanism for a single barrel of a carburetor, generally shown as item 2. It is very usual to have carburetors with multiple barrels, sometimes referred to as throats, making up such as two, three or four barrel carburetors.

FIG. 1 also shows a float bowl 4 and a fuel storage tank 6. The float bowl 6 is a reservoir for the fuel that will be mixed with air and delivered to the one or more barrels of the carburetor. The fuel storage tank 6 is a bulk supply of fuel for ultimate delivery to the float bowl 4 when needed.

The operation of the conventional carburetor seen in FIG. 1 is described by assuming an initial level of fuel in the float bowl 4 sufficient for normal operation of the carburetor. As fuel is delivered to the engine, the level in the float bowl will drop. The lowering fuel level causes the float 8 to begin dropping. As the float drops it allows the needle valve 10 to separate from the needle valve seat 12. A fuel pump 15 forces fuel from the fuel storage tank 6 through the needle valve assembly, allowing the fuel float bowl 4 to begin filling. As the fuel level in the float bowl rises, the float 8 will rise pushing the needle valve 10 against the needle valve seat 12 shutting off the flow of fuel into the float bowl.

A running engine will produce a pressure differential between the booster venturi 14 and atmospheric air pressure in the float bowl 4. This pressure differential causes fuel to flow through the metering jet 16 into the emulsification channel 18. Air 20 flowing into the barrel will flow into the air bleed passage 22 and then mix with the fuel flow through air ports 24. This emulsified mixture of fuel and air 26 is then delivered to the bore of the carburetor through the booster venturi 14. A throttle plate 28 controls the pressure in the carburetor bore. As the throttle plate opens the pressure differential between the booster venture 14 and float bowl 4 will increase causing more fuel flow 26 into the bore of the carburetor.

When the engine is under heavy acceleration, the requirement for fuel delivery through the metering jet 16 cannot be met. An accelerator pump 30 injects extra fuel into a fuel delivery passage to prevent a lean mixture being sent to the combustion chambers of the engine.

As the fuel level in the float bowl 4 can be disturbed by external forces, primarily acceleration forces, an improved system for implementing the float bowl and accelerator pump functions would greatly benefit carburetor operation. FIG. 2 demonstrates how the current invention replaces the functions of the float bowl 4, metering jet 16 and accelerator pump 30 that are present in the prior art carburetor as illustrated in FIG. 1.

FIG. 2 is a simplified embodiment of the invention showing a single barrel carburetor for the sake of clarity. In other, more typical carburetor embodiments, either two or four barrels are used in a carburetor.

In the FIG. 2 illustration, a first injector 50 is used in place of the float bowl 4 and metering jet 16 and accelerator responsive fuel injector 52 replaces the accelerator pump. In this embodiment the fuel pump 54 delivers fuel under pressure from the fuel storage tank 6 to a fuel rail 56 that is connected to the fuel injector 50 and to the accelerator responsive fuel injector 52. These injectors, the first fuel injector 50 and the accelerator responsive fuel injector, act as electronically controlled valves controlling the amount of fuel being sent to the booster venturi 14 located in the barrel of the carburetor through signals sent from a related electronic control device.

Each of the fuel injectors, including the first fuel metering injector 50 and the accelerator responsive fuel injector 52, is controlled by an electronic control unit (ECU.) The ECU is powered from an electrical energy source 62 and supplied with a plurality of signals 64 from sensors measuring a variety of engine parameters. Sensor signals being supplied to the ECU include, but are not limited to, manifold absolute pressure, engine temperature, and throttle position. Sensor signals are converted to the appropriate type for interpretation by the ECU and input to software being executed by the ECU. After calculating fuel requirements for the engine's needs, the proper signal is sent through electrical conduits such as 66 to the fuel metering injector 50 allowing fuel to flow into the carburetor for a specified amount of time. A signal will also be sent to the accelerator responsive fuel injector 52, as fuel is required, normally in an acceleration mode as instigated by a vehicle's operator. During acceleration the fuel metering injector 50 may not be able to provide sufficient fuel to the carburetor bore resulting in a lower than optimal fuel/air ratio. This lean condition will result in a condition where the engine is not performing at maximum power output. The accelerator responsive fuel injector 52 will then receive a signal from the ECU 60 to provide the additional fuel need to keep the engine running at peak performance. The algorithms controlling the accelerator pump injector 52 allow for many different flow rates for the additional fuel requirements as opposed to the conventional carburetor can only supply one rate of additional fuel flow from the accelerator pump system.

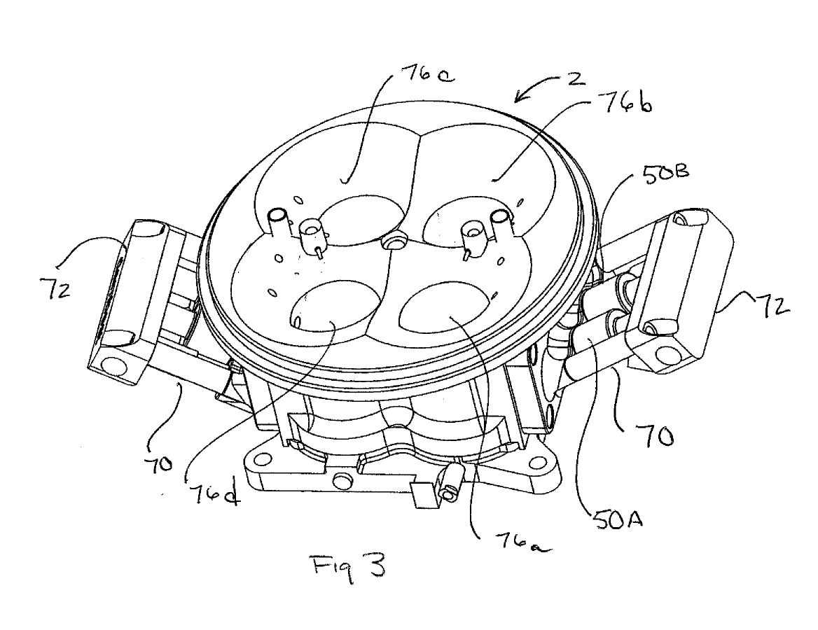

In FIGS. 3-6 a more detailed representation of the carburetor with electronic jets is presented. In these figures the carburetor generally 2 is equipped with injector assemblies 70. In one embodiment a pair of these structures are bolted to the metering blocks of a conventional carburetor. The injector assemblies 70 are not intended to be a replacement for a conventional metering block. However in certain embodiments the conventional metering blocks can be modified or replace with special purpose metering blocks specifically designed to work in concert with various optimized designs of injector assemblies. These injector assembly devices bolt up to the metering block, after removal of the conventional float bowls, to replace the function of the carburetor jet and the accelerator pump on conventional carburetors. The current carburetor metering systems, including emulsion related equipment and passages, is left intact in one embodiment of this embodiment making the retrofitting of the injector assemblies in place of fuel bowls very easy.

The injector assemblies 70 will control the flow of fuel that would normally pass, in a conventional carburetor, from a float bowl to the metering block. This use of the fuel injectors is instead of the use of a convention carburetor metering jet that has been removed from the host carburetor with the replaced float bowl assemblies. The injector assemblies 70, in certain configurations, may also fit Holley®, Barry Grant® and similar style carburetors.

The electronic fuel injectors of the injector assemblies 70 are controlled by an ECU, not shown in the drawings of the carburetor, providing a signal to a first fuel injector 50A, a second fuel injector 50B and to the accelerator responsive fuel injector 52 on each of the injector assemblies 70.

Each bank of injector assembles 70 includes a fuel rail 72 that is plumbed to a supply of fuel that will be supplied to end ports on the fuel log. The fuel injectors 50 A and 50B, as well as the accelerator responsive fuel injector 52, are positioned between the fuel rail 72 and passages leading into and through the metering block 74.

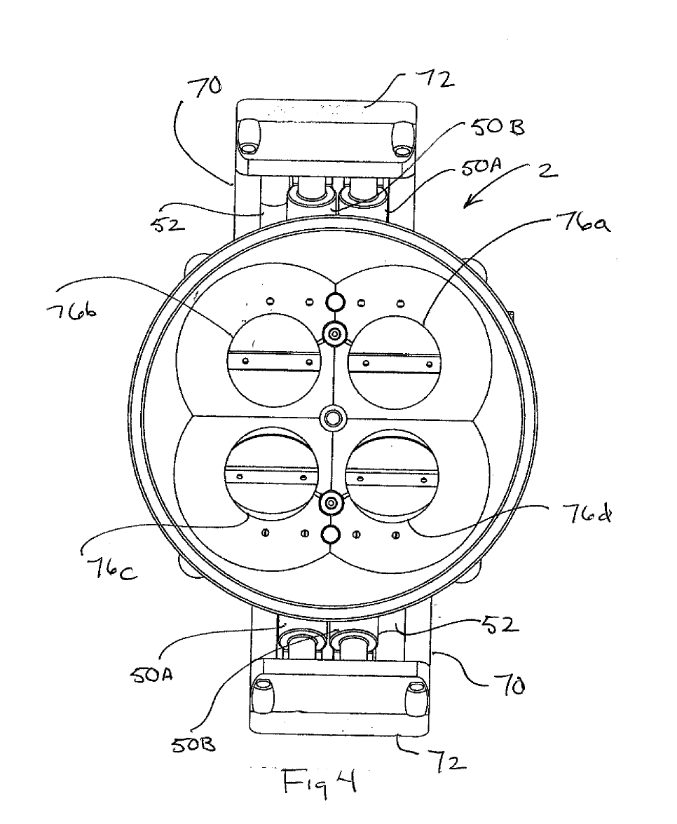

In FIG. 6 the various components are shown in a cross-sectioned view. It is pointed out that in this section the various internal passages in the metering block are not shown, however fuel being delivered through each of the injectors does indeed pass into and through a fluid passage to end up in the throat or barrel, such as barrels 76a-d (in FIG. 4) of the carburetor.

In summary the invention presented herein is carburetor that is electrically connectable to an electronic control module 60. The carburetor has a body with one or more barrels and a fuel supply port in the body of the carburetor leading to each of the one or more barrels of the carburetor. A metering block with first and second surfaces, the second surface of the metering block aligned with the fuel supply port in the body of the carburetor is also part of the carburetor. The carburetor further comprises a first electrically operated fuel injector proximate to, and capable of allowing the delivery of fuel from the fuel injector to the first surface of a metering block. The fuel injector is aligned with a fuel supply port in the metering block and also to a fuel supply port leading from the first surface of the metering block, through the interior of the metering block and exiting through the second surface of the metering block to one of the one or more barrels in the body of the carburetor and a fuel supply port in at least one of the one or more barrel of the carburetor. This is a carburetor that includes electrically operated fuel injectors including an electrically operated accelerator responsive fuel injector proximate the first surface of the metering block. The accelerator responsive fuel injector is aligned with the fuel supply port in the metering block, the fuel supply port leading from the first surface of the metering block through the interior of the metering block and exiting through the second surface of the metering block to a fuel supply port in a first barrel of the carburetor.

In another embodiment of the invention the accelerator responsive fuel injector is operated by signals from the electronic control module independently of the operation of the other fuel injectors mated with the accelerator responsive fuel injector.

Multiple fuel injectors such as a second fuel injector may be located proximate the first surface of the metering block. These second fuel injectors are aligned with a fuel supply port in the metering block just as the first injector is.

The injector assemblies, including the accelerator responsive fuel injector, may also comprise a fuel rail proximate the first and second fuel injectors supplying an un-metered supply of fuel to the first and second fuel injectors at pressure greater than one atmosphere.

The acts performed by the carburetor disclosed herein include a method for increasing the performance of a conventional carburetor. In this carburetor there is a set of fuel injectors that are electrically connected to an electronic control module. The carburetor, having a body and a fuel supply port in the body of the carburetor leading to a barrel of the carburetor, also includes a metering block with first and second surfaces, the second surface of the metering block aligned with the fuel supply port in the body of the carburetor. The method, in summary is performed by positioning a fuel injector proximate a first surface of a metering block. The fuel injector is aligned with a fuel supply port in the metering block, the fuel supply port leading from the first surface of the metering block, through the interior of the metering block and exiting through a second surface of the metering block to the body of the carburetor and a fuel supply port in the barrel of the carburetor. One act in performing the method is that of determining fuel delivery input requirements at the electronic control module. With that information fuel can be metered to the carburetor by operating the fuel injector in response to signals from the electronic control module and using the fuel injector to deliver fuel to the metering block of the carburetor by activating the fuel injector in response to fuel delivery input requirements.

Additionally the act of operating an accelerator responsive fuel injector by signals from the electronic control module may be performed independently of the operation of the first fuel injector.

Multiple fuel injectors may be used in a single carburetor. Usually one fuel injector per carburetor barrel, in addition to an accelerator responsive fuel injector for each injector assembly attached to a carburetor body or metering block, is used. By providing a second fuel injector proximate the first surface of a metering block, the second fuel injector aligned with a fuel supply port in the metering block, the fuel supply port leading from the first surface of the metering block, through the interior of the metering block and exiting through the second surface of the metering block fuel is directed to a second barrel in the body of the carburetor.

While the invention is described herein in terms of preferred embodiments and generally associated methods, the inventor contemplates that alterations and permutations of the preferred embodiments and methods will become apparent to those skilled in the art upon a reading of the specification and a study of the drawings.

Accordingly, neither the above description of preferred exemplary embodiments nor the abstract defines or constrains the invention. Rather, the claims variously define the invention. Each variation of the invention is limited only by the recited limitations of its respective claim, and equivalents thereof, without limitation by other terms not present in the claim.

What is claimed is:

1. A carburetor, electrically connectable to an electronic control module, the carburetor having a body with one or more barrels and a fuel supply port in the body of the carburetor leading to each of the one or more barrels of the carburetor, a metering block with first and second surfaces, the second surface of the metering block aligned with the fuel supply port in the body of the carburetor, the carburetor further comprising:
a first electrically operated fuel injector proximate the first surface of a metering block, the fuel injector aligned with a fuel supply port in the metering block, the fuel supply port leading from the first surface of the metering block, through the interior of the metering block and exiting through the second surface of the metering block to one of the one or more barrels in the body of the carburetor and a fuel supply port in at least one of the one or more barrel of the carburetor;
an electrically operated accelerator responsive fuel injector proximate the first surface of the metering block, the accelerator responsive fuel injector aligned with the fuel supply port in the metering block, the fuel supply port leading from the first surface of the metering block, through the interior of the metering block and exiting through the second surface of the metering block to a fuel supply port in a first barrel of the carburetor.

2. The invention in accordance with claim 1 further comprising the accelerator responsive fuel injector operated by signals from the electronic control module independently of the operation of the first fuel injector.

3. The invention in accordance with claim 2 further comprising a second fuel injector proximate the first surface of a metering block, the second fuel injector aligned with a fuel supply port in the metering block, the fuel supply port leading from the first surface of the metering block, through the interior of the metering block and exiting through the second surface of the metering block to a second barrel in the body of the carburetor.

4. The invention in accordance with claim 3 further comprising a fuel rail proximate the first and second fuel injectors supplying an un-metered supply of fuel to the first and second fuel injectors at pressure greater than one atmosphere.

5. The invention in accordance with claim 4 further comprising the accelerator responsive fuel injector being connected to the fuel rail.

6. A method for increasing the performance of a carburetor electrically connected to an electronic control module, the carburetor having a body and a fuel supply port in the body of the carburetor leading to a barrel of the carburetor, a metering block with first and second surfaces, the second surface of the metering block aligned with the fuel supply port in the body of the carburetor, the method comprising the acts of:
positioning a fuel injector proximate a first surface of a metering block, the fuel injector aligned with a fuel supply port in the metering block, the fuel supply port leading from the first surface of the metering block, through the interior of the metering block and exiting through a second surface of the metering block to the body of the carburetor and a fuel supply port in the barrel of the carburetor;
determining fuel delivery input requirements at the electronic control module;
metering fuel to the carburetor by operating the fuel injector in response to signals from the electronic control module and using the fuel injector to deliver fuel to the metering block of the carburetor by activating the fuel injector in response to fuel delivery input requirements.

7. The method in accordance with claim 6 further comprising the act of operating the accelerator responsive fuel injector by signals from the electronic control module independently of the operation of the first fuel injector.

8. The method in accordance with claim 7 further comprising the act of providing a second fuel injector proximate the first surface of a metering block, the second fuel injector aligned with a fuel supply port in the metering block, the fuel supply port leading from the first surface of the metering block, through the interior of the metering block and exiting through the second surface of the metering block whereby fuel is directed to a second barrel in the body of the carburetor.

9. The method in accordance with claim 8 further comprising the act of providing a fuel rail proximate the first and second fuel injectors supplying an un-metered supply of fuel to the first and second fuel injectors at pressure greater than one atmosphere.

10. The method in accordance with claim 9 further comprising the act of connecting the accelerator responsive fuel injector to the fuel rail.
